(19) United States
(12) Patent Application Publication
(10) Pub. No.: US 2014/0059451 A1
(43) Pub. Date: Feb. 27, 2014

(54) ASTRAL MEDIA AND METHOD OF USE

(71) Applicant: "DUVAMIS" EOOD, Sofia (BG)

(72) Inventor: Dobromir Hristov GOUSHTEROV, Sofia (BG)

(73) Assignee: "DUVAMIS" EOOD, Sofia (BG)

(21) Appl. No.: 13/897,442

(22) Filed: May 20, 2013

(30) Foreign Application Priority Data
Aug. 22, 2012 (BG) 111296

(51) Int. Cl. H04L 29/06

(52) U.S. Cl. CPC H04L 65/403
USPC 715/753

(57) ABSTRACT

The astral media is applied in the online communication or in a computer network structure between users and provides them with an opportunity to be anonymous using a random number of virtual visions. The users (1) whose number is unlimited may via user devices (2) use the Internet or another network environment (3) to access the media (4). After creating a user account (5) the users (1) create one or more virtual visions (8) through which they access the multilayered communicative fragmentation (9) of the astral media (4). The multilayered communicative fragmentation (9) consists of at least a “Public Lemma” (10), “Legion Lemma” (11) and “MySelf Lemma” (12). The “Public Lemma” (10) is universally accessible to all virtual visions (8) and the content they generate is visible to the other visions. In the “Legion Lemma” (11) the virtual visions (8) form groups of closed legions (13) accessible only to the members. The “MySelf Lemma” (12) is to be used only by its creator. It does not entail communication between virtual visions (8). The connection between the creator and the “MySelf Lemma” (12) is direct with the creator having to own at least one own virtual vision (8).

### CROSS-REFERENCE TO RELATED APPLICATIONS

This application claims priority to, and the benefit of, under 35 U.S.C. 119, Bulgarian Patent Application No. 111296, filed on Aug. 22, 2012, the disclosure of which is incorporated herein in its entirety.

### TECHNICAL FIELD

This invention refers to an astral media and a method for its use, which will be applied to Internet communication or another type of computer network structure for different users.

### BACKGROUND OF THE INVENTION

There are existing social networks whereby each user upon logging into the system creates their own user account which should reflect the user's social characteristics such as Name, Surname, Family Name, Gender, Age, etc. The user accounts thus created could be then grouped in what the networks refer to as “friends' circles” and the main communication is closed within the circle without direct contact with the majority of users in the social network. The information from the user account is accessible for communication with other users from the respective user's circle of friends, but there are no direct methods for users outside the circle to find this information. Information could be exchanged and communication could be carried out via text messages and/or media files (photographs, audio, and video), which when posted are identified with the social characteristics of the author as entered into his/her user profile and are mainly accessible, unless otherwise specified, to his/her circle of friends or in some cases other users close to this circle (friend of a friend). (U.S. Pat. No. 8,010,458).

The disadvantage that we see in the existing social network model is the lack of social anonymity, which makes it impossible for a large number of users to communicate freely thus being able to be “themselves” in sharing different opinions, interests, ideas and/or other functionalities of the existing networks.

### SUMMARY OF THE INVENTION

A goal of this invention to create an astral media which unlike other media and networks in social life to really cover the meaning of the Latin word “media” as a mediated communicative space where the rules ensure that each user has communicative access to other users not based on social characteristics but rather on certain themes, desires or any other usefulness as perceived by the creator but through clearly regulated opportunity to enjoy full social and biological anonymity via functionalities allowing for the creation of an unlimited number of virtual visions.

The astral media should allow its users, referred to in it as “Creators”, to establish a new astral community comprising the supreme projections of the human mind and thought such as the “Virtual Visions” which “Virtual Visions” serve as their face in the astral world providing the social anonymity that the current social network model lacks—this is a precondition for a real, desired and free communication among them based on connections being established in terms of themes or other user perceived usefulness.

This goal is solved by having an astral media positioned in a computer network, mainly Internet, whose users could access the media's services via user devices connected with the computer network and upon registration that requires minimum user data in order to maintain user anonymity. The registered users use this astral media and communicate indirectly by creating at least one own virtual vision. Having set up at least one virtual vision each registered user becomes a creator. Every virtual vision created ensures its creator absolute social, biological, regulated, mediated anonymity in a multilayered communicative fragmentation. This multilayered communicative fragmentation consists, but is not limited to, a “Public Lemma”, “Legion Lemma”, and “MySelf Lemma”. The options for communication between the virtual visions are narrowed down to the “Public Lemma” and the “Legion Lemma”, whereas the “MySelf Lemma” is the individual virtual space of each creator.

The actions of all creators in the astral media are mediated via their virtual visions and are taking place in astronomical and/or specially measured astral media time.

The user interface of the first two lemmas is divided into left-hand and right-hand sections with the left-hand containing information visible only to the respective creator, and the right-hand section serving for communication between the different virtual visions in the astral media. The user interface of the “MySelf Lemma” is not divided into left-hand and right-hand sections, but is a single creator-unique desktop. This user desktop can be customized according to the preferences of its creator.

In this astral media the “Public Lemma” is universally accessible for all virtual visions of all the creators logged in the media with each content uploaded and each action of a creator's virtual vision at the level of public communication in the media, as well as each virtual vision created being visible and accessible for interaction by all other virtual visions.

The visualization of the “Public Lemma” has two parts—a left-hand section called “Fountain” and a right-hand section called “Arena”—divided by a frame which suggests a two-part door. The left-hand section—the “Fountain”—which is visible only to the creator whose account visualizes the astral media, consists of elements assisting in the creation of virtual visions as well as any other content supported as functionality by the “Public Lemma”. The right-hand section—the “Arena”—is universally accessible to all users via the virtual visions created by them and visualizes all interactions between the virtual visions created in the public communicative layer of the astral media. What is more, every content created by the virtual visions in the “Public Lemma” is grouped based on fundamental type features called elements facilitating the grouping and the subsequent finding of the sought content or of other virtual visions by using the specific elements for browsing or algorithms for content provision or visions and/or other search mechanisms.

The “Legion Lemma” is the restricted access part of the media comprising a large number of legions each of which being a closed communication community and consisting of at least two virtual visions. The content uploaded in the respective legion is visible only to its members and each virtual vision can take part in an unlimited number of legions. Also each content created in the media is grouped based on fundamental type features, called elements facilitating the finding of appropriate content or of other virtual visions.

The visualization of the “Legion Lemma” is formed of two parts—a left-hand section called “Fountain” and a right-hand section called “Arena” and visualizing only one “Legion”. The left-hand section “Fountain”, visible only to its creator, consists of elements facilitating the creation of the content specific to the legion selected in the right-hand section. The right-hand section is characterized by a visualization of the interactions between the member virtual visions in the respective selected legion.

The “MySelf Lemma” is directly connected with the creator and constitutes his/her personal, inapproachable, personalized space in the astral media invisible to the other creator-members of the astral media. The “MySelf Lemma” provides options for installing and using any user device connected in the network and of various software products. Such products could be file upload and conversion software, text and graphic editors, news readers for news content from external sites, systems for managing the creator's virtual visions in the astral media, as well as any other software allowing for one-way action initiated exclusively and only by the specific creator within the media.

Each virtual vision of this media ensures full protection of the social-biological identity and anonymity of its creator. This is achieved by the building of specific characteristics for the specific virtual visions such as name, description, avatar and others that the creator may be willing to share with the astral world. Each of the characteristics of the virtual vision with on exclusion of its name may be changed in time by the creator of the virtual vision.

By using the virtual vision, its creator may freely and indirectly communicate with all the virtual visions of the other creators in the astral media in a manner that s/he sees as appropriate and which is acceptable in the astral media. The creator may freely operate with the virtual vision being able to change, delete, revive, leave as a memory for the other members in the astral media, as well as bequeath, transfer and sell it to other creators using their virtual visions.

The creator also has the opportunity to objectify the virtual vision at a present or future time as s/he chooses.

The measurement of time intervals relating to media actions is also done in virtual terms different from the astronomical time measurement and 8.33 times faster than the astronomical time.

The method of using the astral media involves the following sequence of operations:

Using computer networks and user devices the users connects to the astral media and logs into the system of the astral media. Upon registration each user is obliged to create at least one virtual vision to be able to use the services of the astral media. Via the created virtual vision the user, who is now a creator, acquires the chance of communicating in the “Public Lemma” and the “Legion Lemma” with other creators via the virtual visions they have created and objectified. Unlike the “Public Lemma” and the “Legion Lemma” the use of the “MySelf Lemma” is direct between the creator and the astral media, but still in order to use it the creator should have at least one active virtual vision.

In the “Public Lemma” each creator using at least one of his/her virtual visions could chose to carry out some or all, but not limited to, the following operations:
Browse and/or search for content or other virtual visions;
Create content in a specific element of the “Arena”;
Comment on content in each specific element of the “Arena”;
Delete their own posted content in a specific element of the “Arena”;
Classify based on certain features (themes) the information content posted by them and group in terms of meaning the general content posted by all creators via their virtual visions in different elements of the “Public Lemma” while at the same time being able to indirectly use the same criteria to classify all the virtual visions interested in specific content relating to the theme;
Like, dislike or save content in their favorite content collection for a specific element of the “Arena”;
Establish public contacts with other virtual visions using, but not only, a special public dialog element;
Share public audio, video, graphic, text and other files in a special element of the “Arena”;
Create and vote for certain type of referendum issues;
Operate and manage their own virtual visions by bequeathing, leaving as memory, deleting them, etc.; and
Communicate via their virtual vision with other virtual visions in order to form legions in the “Legion Lemma”.

In the “Legion Lemma” the virtual visions of the creators form communication groups called “Legions” which are closed for access by non-member virtual visions and which possess their own differentiating characteristics selected by the members. The formation of legions is done by creating new legions or by a member of an already established legion inviting a non-member virtual vision to join. Creating a new legion or issuing an invitation for an existing one in the “Legion Lemma” is to be done based on prior communication between at least two virtual visions at “Public Lemma” or “Legion Lemma” levels. The visualization of this contact between the two virtual visions is positioned in a particular place in the right-hand sections of the two lemmas following which one virtual vision invites the other to create or join an existing legion. This invitation could be accepted or not. In case the invitation to create a new legion is accepted, the astral media makes it possible to form legion characteristics via a computer process shown in a special user interface allowing for expressing consensus regarding the differentiating characteristics the legion as proposed by both sides (the two virtual visions). These characteristics need to be approved by both virtual visions. The legion thus created is only visible to the virtual visions of its members so the information posted in the legion is only accessible to them. In case the invitation is not accepted by one of the virtual visions, no legion is created.

If a virtual vision is invited to join an already existing legion, the astral media system first allows the legion members to decide and vote on approving the new member. Only after the invitation is approved by the members, the system makes it possible for the invited virtual vision to decide whether to join or not the legion.

The legion members may carry out some or all, but not limited to, the following operations:
propose to all the legion members to accept new members or to change old differentiating characteristics of the legions they are part of such as “Name”, “Avatar”, “Presentation”, “Rules”, and others as the virtual visions may consider necessary;
create content in a manner similar to that in the “Arena” of the public section of the astral media;
enter into real-time communication with the other members of the respective legion;
share computer files and internet links by setting up special legion libraries;
indicate their willingness to take part or not in planned events posted in the special element of the legion;
share with the other members of the legion content posted by them or by other non-member virtual visions in the “Public Lemma”;
freely leave a given legion and opt to send a message to that effect; and
propose the exclusion of members to the legions they take part in.

The inclusion of new members in a legion that has already been created in the “Legion Lemma” is done after a prior decision of the legion members is taken as to whether the approval requires full, qualified or simple majority of the vote of the member virtual visions.

The termination of membership in a legion that has already been created in the “Legion Lemma” takes place after a prior decision of the legion members is taken as to whether the approval requires full, qualified or simple majority of the vote of the member virtual visions.

The legion is active as long as it has more than one virtual vision as a member.

The change of the characteristics of a legion that has already been created in the Legion Lemma shall be done after a prior decision of the legion members is taken as to whether the approval requires full, qualified or simple majority of the vote of the member virtual visions.

Any other change relating to major changes in the legion, i.e. everything excluding the posting of content by the legion virtual visions, shall be approved by voting by the legion members.

The astral media has an “urgent messaging” option by way of ensured and guaranteed access between the virtual visions. Each virtual vision may indirectly communicate with the creator of the virtual vision that authorized it regardless of where in the astral media the creator is and which other virtual vision they navigate at this moment.

The advantages of the astral media can be summarized as follows:

The astral media allows for full individual freedom with the user being able to create and operate many own or acquired virtual visions. In this way each user becomes a creator and navigator of virtual visions which is the first time that the individual receives recognition as the main creator of the astral world, of his/her human world of thought. It is not only that the user of the astral media is recognized for the first time as a true creator, creator of virtual visions, but they can truly decide the fate of these visions by navigating their virtual existence and communication as well as by using the option provided by the astral media to change, save, leave as memory and even revive virtual visions that they created.

The astral media allows for regulated, free, mediated, open and non-damaging communication among all users via virtual visions in the astral community formed where the restrictive social and biological differences from the real world—gender, age, appearance, nationality and religious beliefs, social status, profession, family status or wealth—do not count and only the mental limitations (skills, capabilities) of the user creating the virtual vision matter.

In the astral media each user has the personal freedom as regulated in the media to create and operate with the virtual visions created by him/her and can free up their internal world of imagination and needs. The user has the right to create virtual visions using his/her own imagination, to observe and indirectly communicate with other virtual visions, to accept or not accept contacts, to form closed communities of virtual visions called “legions” with other virtual visions, to bequeath or transfer their visions for navigation, to terminate their existence or revive them in the astral media.

The astral media makes it possible for the user to be a creator. It also serves as an opportunity to enjoy the most harmonious virtual existence in the new multilayered time astral space which in no way contravenes with the user's social or biological nature. The contrary is in fact true, this is the emotional and spiritual closure that the individual has been striving after for thousands of years.

Only virtual visions, and not their creators as users, take part and communicate in the astral media. This condition makes it possible to both ensure full protection of the social and biological identity of the user, and safeguard the spiritual freedom of the creator.

The astral media is not a social network, but it is not a web-based game either. It is a platform for interactions in the new possible astral community.

The virtual vision is not in itself an “avatar”, although the media does provide for an opportunity of the user to support the creation of their virtual vision by using an “avatar”. The avatars as they have been known are not the essence of virtual visions, even though this type of visions have so far been the most popular in the understanding of the people. The virtual vision is a manifestation of the internal individual needs hidden in the suppressed reflexive mind of the social personality since it is easily recognizable through the freely expressed relations, and is not an animation of a social and biological simulacrum online. In this way this is a real, but mediated and hence a free form of communication among users via free virtual visions, and not the restrictive social and biological identities.

### BRIEF DESCRIPTION OF THE DRAWINGS

FIG. 1 shows the main process scheme for accessing the services of the astral media.

FIG. 2 shows the mediated communication of the creator with the astral world.

FIG. 3 shows communication in the Public Lemma.

FIG. 4 shows visualization of the Public Lemma.

FIG. 5 shows communication in the Legion Lemma.

FIG. 6 shows visualization of the Legion Lemma.

FIG. 7 shows interaction of the creator in the MySelf Lemma.

FIG. 8 shows visualization option for the MySelf Lemma.

### DETAILED DESCRIPTION OF THE INVENTION

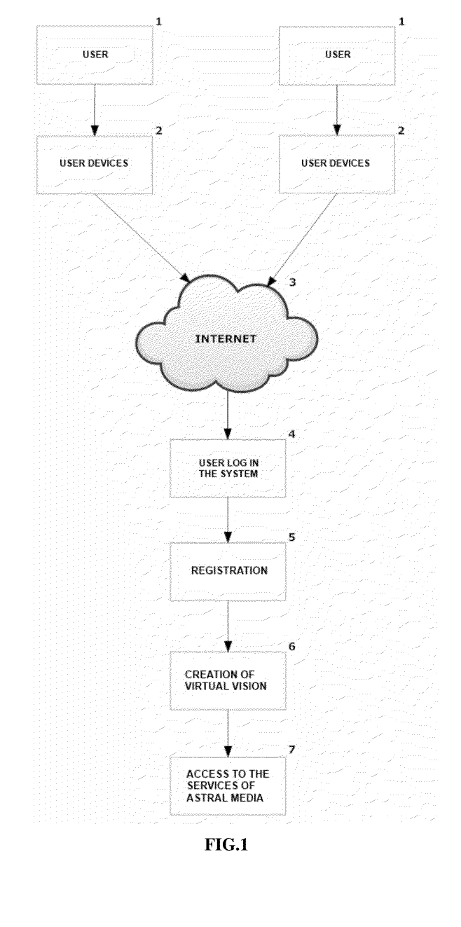

The invention involves the Internet users 1, whose number is unlimited via their user devices 2 (tablets, mobile devices, PCs and others) being able to use the Internet environment 3 or another network environment to access the site of the astral media 4—FIG. 1. Upon accessing the home page of the astral media 4, the users 1 join the media 4 by filling the registration form 5. The registration form 5 is a computer code allowing the creation of unique entry in the data base of the astral media 4, and the creation of an unique user account. Only after an user account is created in the registration form 5, the users 1 can perform operation 6 for creation of the first virtual vision and thus become creators.

As mentioned above the astral media 4 provides all pre-requisites for the anonymity of creator 1 by allowing the creation of one or more virtual visions which are the only tool the user can use to maintain regulated and mediated communication with other creators 1 in the astral media 4. The appearance of the virtual vision is not limited by the astral media 4 and it could depict any idea of the creator 1 such as a song, a poem, a person, a being and anything else the creator's mind may produce. The astral media 4 does not promote direct contact between the social and biological characteristics of the creators 1, but only between their mental projections.

Access to the services 7 provided by the astral media 4 is only possible upon the creation of at least one active virtual vision of the creator 1.

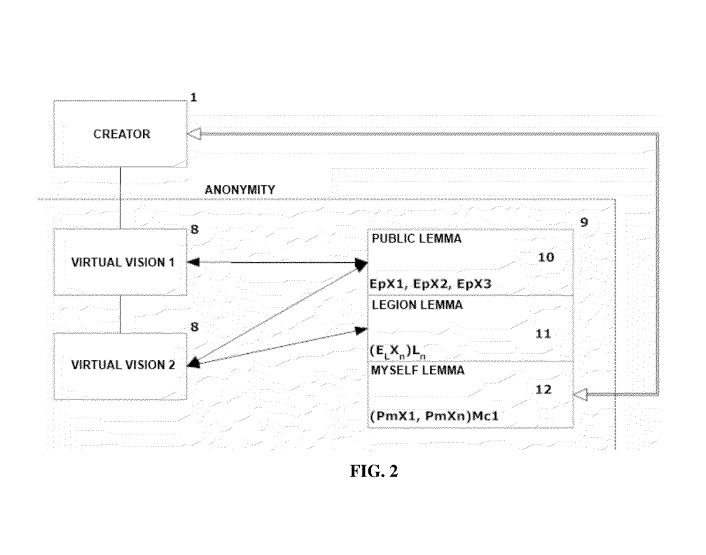

After registering 5 the creator account the user 1 remains anonymous and nowhere is there public information about the specific social person logged in the astral media 4. Only upon creating at least one virtual vision 8—FIG. 2 the multilayered communicative fragmentation 9 of the astral media 4 becomes accessible for indirect communication between the logged creator 1 and all the other creators logged in the astral media 4, but via the virtual visions 8 they created. Every virtual vision created allows its creator absolute social-biological, regulated, mediated anonymity in the multilayered communication fragmentation.

The multilayered communication fragmentation 9 consists of a certain number of, as determined by the specificity of the astral media 4, communication environments with different level of access to the content posted by the creators, mediated via their visual visions.

The multilayered communication fragmentation 9 is composed of, but not limited to, three communication environments called lemmas—Public Lemma 10, Legion Lemma 11 and MySelf Lemma 12. The Public Lemma 10 is universally accessible for all the virtual visions 8 and each vision and every content generated by it, grouped by types of features, called elements (EpX1, EpX2, etc.), is visible to the other participants (creators) in the astral media 4, but only via the virtual visions 8 created by them.

The Legion Lemma 11 is not universally accessible. In it the virtual visions 8 may form an unlimited number of closed groups, called “legions” 13. Only the members can access the content generated in a given “legion” 13.

The MySelf Lemma 12 is meant only for the creator 1. In it no communication takes place between virtual visions 8 and the connection between the creator 1 and the MySelf Lemma 12 is direct, and not mediated, but in order for it to be accessible the creator 1 needs to have at least one virtual vision 8 created. Each creator 1 builds his/her own MySelf Lemma which is not accessible for the other creators and in which s/he can use different types and numbers of applications ((PmX1, PmXn)Mc1).

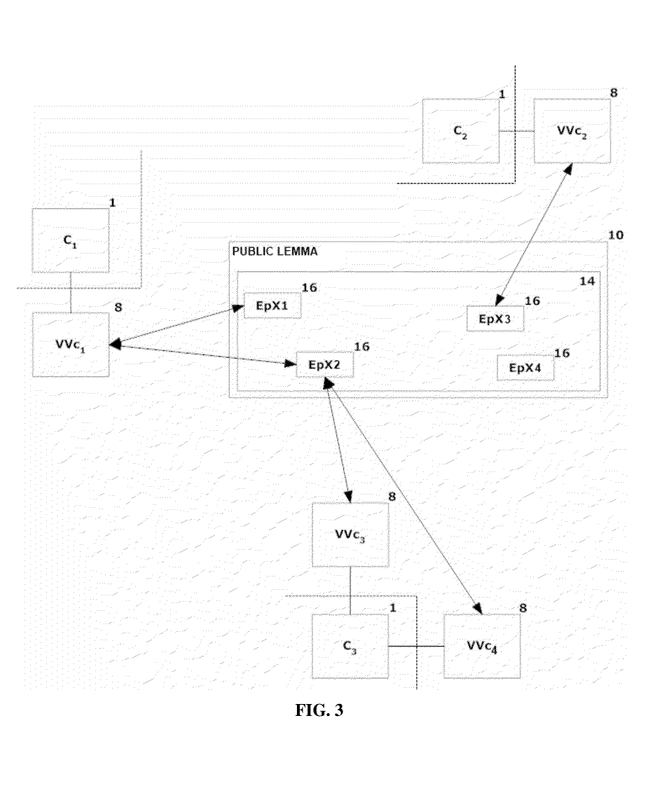

The communication in the “Public Lemma” 10 takes place based on a principle of universal access—FIG. 3. The typical characterization of this communication is that all content posted in the Public Lemma 10 is visible and accessible to all creators, the characteristics of each virtual vision are visible and the virtual vision is accessible for communication. Thus for instance the virtual vision VVc1 of the creator C1 on FIG. 3 performs two types of interactions with the Public Lemma 10 of the astral media 4 by posting content in element 16 of the Public Lemma 10-EpX1 where there are no associated dialog with other virtual visions, and then communicates with virtual visions VVc3 and VVc4 of creator C3 with creator C1 not having direct information provided by the astral media 4 that the two belong to the same creator 1.

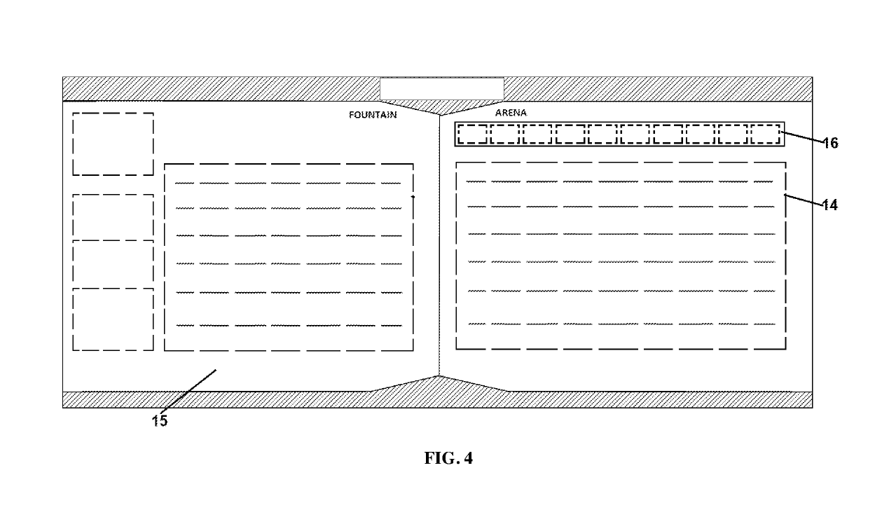

Visually, the “Public Lemma” 10 is composed of “Public Arena” 14 in the right-hand section of the user screen, and “Fountain” 15 in the left-hand section of the user screen as shown in FIG. 4. The two parts of the “Public Lemma” are divided by a frame suggesting a two-part door. What is specific about this division is that “Fountain”—the left-hand section of the user interface—contains all the forms for creating and publishing content in the “Public Arena” 14—right-hand section of the user interface. This content can be texts, photographs, video, music, etc. The rationale for such a division is to project closeness to the creator—the left-hand section being that of the heart thus highlighting a feeling of concealment and protection of the creator.

The communication between the creators 1—FIG. 3 is carried out via the mediation of their virtual visions 8 with them being able to communicate in the “Public Arena” 14 where each action of each virtual vision 8 is visualized at that communication layer as well as each created virtual vision 8 in the astral media 4 being accessible for communication by all other creators 1 via their virtual visions 8. The communication between the virtual visions 8 on the “Public Arena” 14 takes place by way of additional classification and categorization of content using elements 16 which are also visualized in FIG. 4. Elements 16 are a preliminary categorization which selects the virtual visions 8 authors of the content posted in the Public Arena 14. Such elements can be—“search of virtual visions”, “encyclopedic content”, “themes and discussions”, “public conversions”, “element for browsing multimedia content”, “element for voting” as well as any other theme determined by the astral media 4 as appropriate for element 16 of the “Public Arena” 14.

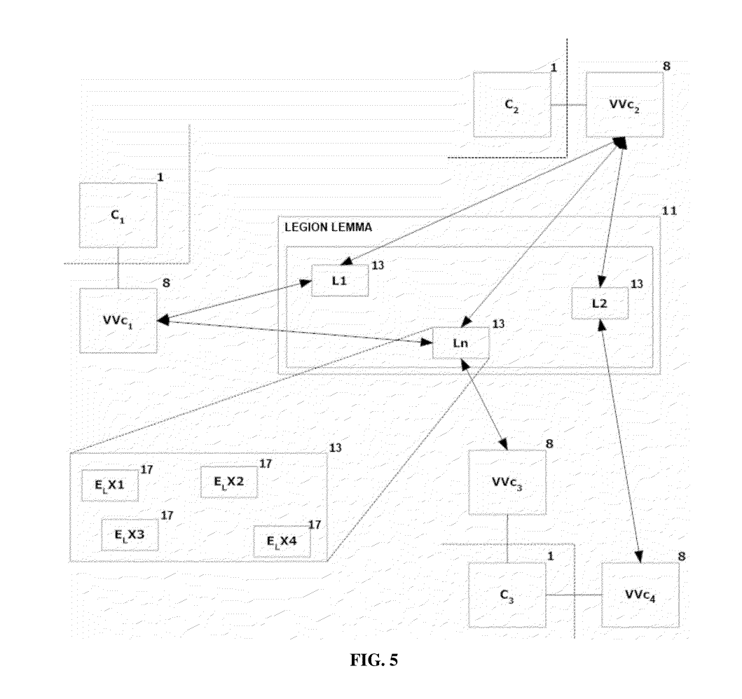

The Legion Lemma 11 is the second communication layer in the astral media 4. The Legion Lemma 11 consists of a large number of legions 13—FIG. 5. Each of these legions 13 is a closed communication community created by at least two virtual visions 8. Creating one legion 13 requires communication between two virtual visions 8 taking place at a special place in the Public Arena 14 or the Legion Lemma 11 and then an invitation to create the respective legion 13 sent by one of the two communicating virtual visions 8 to the other. This invitation may be accepted or not accepted. If the invitation is accepted, the legion 13 of the two virtual visions 8 is created in Legion Lemma 11 and is accessible only to them. This takes place after a prior agreement is reached via the system instruments of the astral media 4 to enter differentiating and other characteristics of the legion 13.

Other virtual visions 8 could join the legion 13 thus created. Again this is done by way of a conversation and an invitation sent by one of the legion 13 members to another virtual vision 8, but only upon express approval (vote) of the member virtual visions 8 of this legion 13.

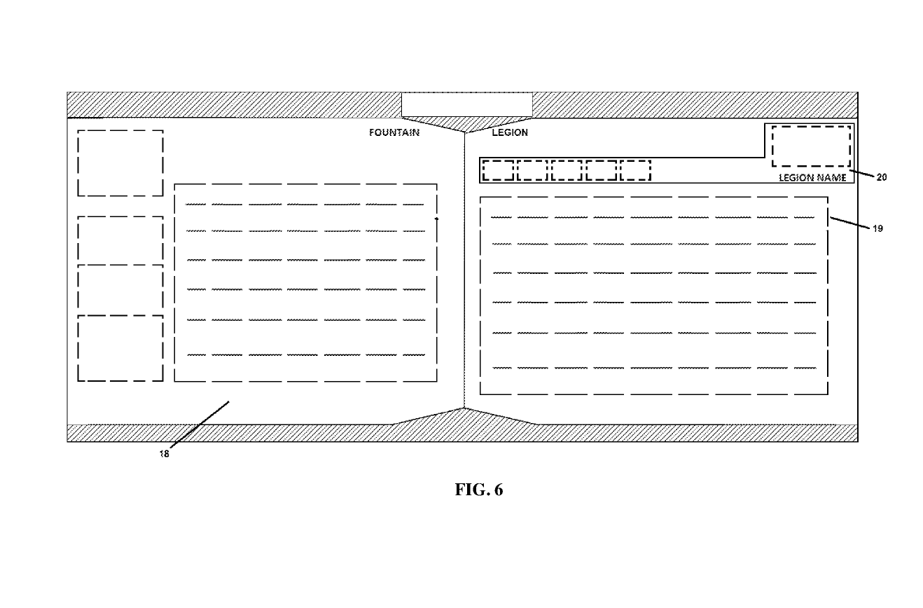

FIG. 5—the communication between the virtual visions 8 in the different legions 13 is carried out through additional categorization and classification of content using elements 17 visualized in FIG. 6. Elements 17 are a preliminary categorization selected by the virtual visions 8 that are authors of the content posted in a specific legion 13.

An example communication among a limited number of virtual visions in the legion lemma is shown on FIG. 5. Virtual vision VVc1 of creator C1 is a member of two legions:

In legion L1 he participates only with virtual vision VVc2 of creator C2.

In legion Ln he participates again with virtual vision VVc2, but also with virtual vision VVc3 of creator C3.

Visually the Legion Lemma 11 is shown in the user interface similarly to the Public Lemma 10 by dividing it into two sections—the left-hand Fountain 18 and the right-hand Legion 19 as shown in FIG. 6.

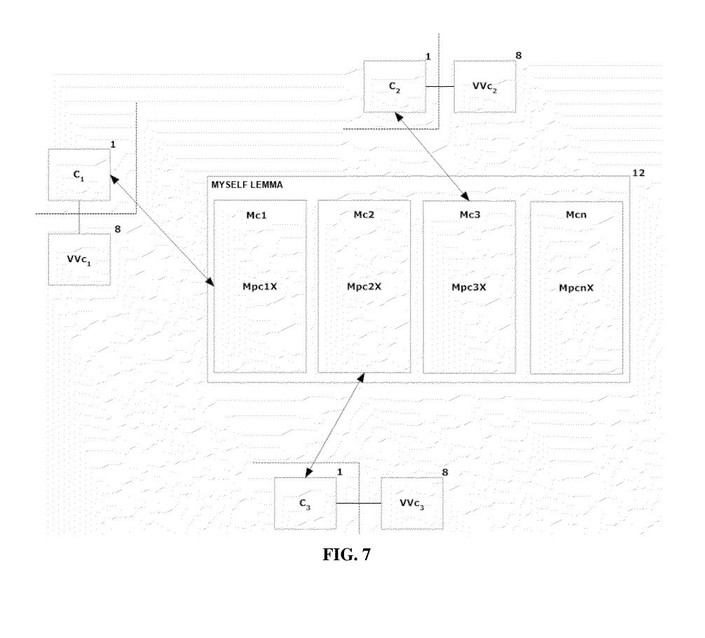

As highlighted above the MySelf Lemma 12 is to be used by each creator individually FIG. 7. It does not contain virtual visions 8 to communicate with, but only tools which assist the creator 1 in creating different types of content. The connection between the creator 1 and the MySelf Lemma 12 is direct. This is the personal and protected space of the creator 1 in the astral media 4 which ensures his/her social and biological anonymity. In this Lemma the creator 1 is on his/her own and cannot be accessed directly or indirectly (via virtual visions 8) for communication with other creators 1. In the MySelf Lemma 12 the astral media 4 offers to the creators software they can use such as but not limited to text and graphic editors, tools for the creation and management of virtual visions 8 as well as for their deferred objectification in the astral media 4, as well as any other software as defined by the astral media 4 and respecting the anonymity of the social person. As shown on FIG. 7 each creator 1 in the astral media 4 has his/her own space in the MySelf Lemma 12 that is invisible to the other creators and which they can customize and use as they deem appropriate. The customization of this space could entail changing the color themes of the interface, adding images as desktop wallpapers, installation of certain applications marked as Mpc1X, Mpc2X, Mpc3X, etc. as shown on FIG. 7 and which are part of the sum of available applications in the astral media 4.

The purpose of the MySelf Lemma 12 is to allow the creator 1 to build and organize their personal virtual space. The creator can create, process, delete and use different files in terms of type and content, to manage his/her virtual vision 8 as well as other functionalities without revealing his/her social identity. The personal space thus created is part of the astral media 4 and is accessible only to its creator 1 from any user device 2 connected in a network environment 3 with the astral media 4 servers.

Another feature of this astral media 4 is that it allows for the deferred creation of virtual vision 8. What is typical for this virtual vision is that it remains inactive in the astral world 4 until the moment its creator 1 has specified as the moment when the vision should enter the world and perform a certain action—for instance publish content in the Public Arena 14 or use any other functionality available in the astral media 4.

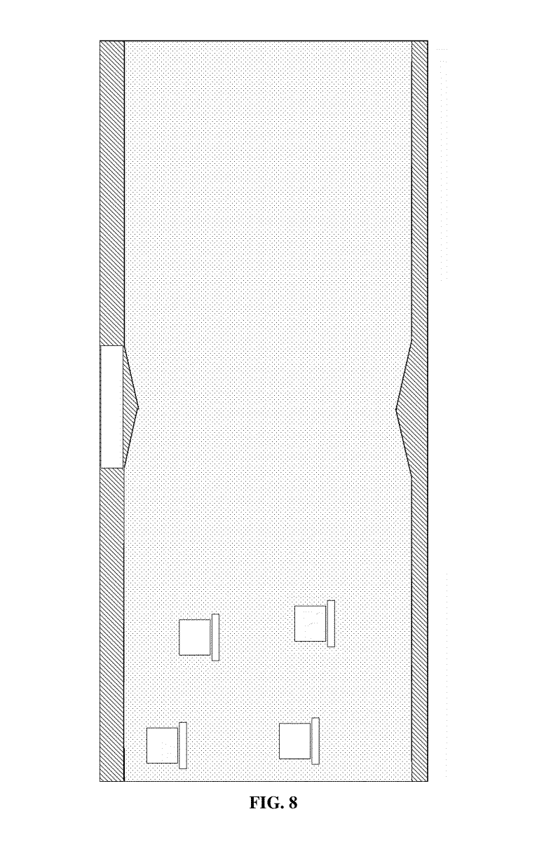

Visually, the MySelf Lemma 12 is different from the other two lemmas. One of the versions of the MySelf Lemma is shown in FIG. 8. In this version there are no left-hand and right-hand sections but a single desktop of the creator 1 which can be customized in accordance with the creator's preferences in terms of color themes and background.

A specific feature of this astral media is that the measurement of time intervals relating to actions in the media 4 is also done in virtual terms which differ from the astronomical measurement and are 8.33 times faster.

The method of using the astral media is characterized by the following sequence of operations:

The creators 1 connect to the astral media 4 via computer networks 3 and user devices 2 (tablets, mobile devices, PCs and others). Then the users 1 log on the system of the astral media 4. Upon registration 5 each user should create at least one virtual vision 8 in order to be able to use the services of the astral media 4. Using the created virtual vision 8 the user 1 who has become a creator 1 is objectified in the astral media 4 and can freely communicate in the Public Lemma 10 and the Legion Lemma 11 with other creators 1 via the created and objectified virtual visions 8. To use the MySelf Lemma 12 the creator 1 needs to have at least one active virtual vision 8.

In the “Public Lemma” 10 each creator 1 via at least one of his/her virtual visions 8 can perform some or all, but not limited to the following operations:
Browse and/or search for content or other virtual visions 8;
Create content in a specific element 16 of “Arena” 14;
Comment on content in a specific element of “Arena” 14;
Delete their own content posted in a specific element 16 of “Arena” 14;
Classify based on certain features (themes) the information content posted by them and group in terms of meaning the general content posted by all creators 1 via their virtual visions 8 in different elements 16 of the “Arena” 14 while at the same time being able to indirectly use the same criteria to classify all the virtual visions 8 interested in specific content relating to the theme;
Like, dislike or save content in their favorite content collection for a specific element 16 of the “Arena” 14;
Establish public contacts with other virtual visions 8 using special element 16 for public dialog of “Arena” 14;
Share public audio, video, graphic, text and/or other files in a special element 16 of the “Arena” 14;
Create and vote for in certain type of referendum issues part of elements 16 of “Arena” 14;
Operate and manage their own virtual visions 8 by bequeathing, leaving as memory, deleting and/or performing other operations with them, etc.; and
Communicate via their virtual visions 8 with other virtual visions 8 of other creators 1 or with their own virtual visions in order to form legions 13 in the “Legion Lemma” 11.

In the Legion Lemma 11 the virtual visions 8 of the creators 1 form communication groups called Legions 13 which are closed for access by non-member virtual visions and which possess their own differentiating characteristics as selected by the members. The formation of the legions 13 is done by at least two virtual visions 8 or by a virtual vision 8 in an already established legion inviting a non-member virtual vision 8 to join an existing legion 13. Creating a new legion 13 or issuing an invitation for an existing one in the “Legion Lemma” 11 is to be done based on prior communication between at least two virtual visions 8 at “Public Lemma” 10 or “Legion Lemma” 11.

The visualization of this contact between the two virtual visions 8 is positioned in a particular place in the right-hand sections of the two lemmas—for the “Public Lemma” 11 the contact is positioned in “Arena” 14, and for the “Legion Lemma” 11 the contact is placed in the right screen of the users interface—the position is “Legion” 19 as shown on FIG. 4. Subsequently one virtual vision 8 invites the other to create a new legion 13 or an invitation is send to join an existing legion 13. This invitation could be accepted or not. In case the invitation to create a new legion 13 is accepted, the astral media 4 makes it possible to form legion characteristics via a computer process shown in a special user interface allowing for expressing consensus regarding the differentiating characteristics of the legion 13 as proposed by both sides. These characteristics need to be approved by both virtual visions 8. The legion 13 thus created is only visible to the virtual visions 8 of its members so the information posted in the legion 13 is only accessible to them. In case the invitation is not accepted by one of the virtual visions 8, no legion 13 is created.

If a virtual vision 8 is invited to join an already existing legion 13, the astral media 4 system first allows the legion 13 members to decide and vote on approving the new member. Only after the invitation is approved by the members, the system makes it possible for the invited virtual vision 8 to decide whether to join or not the legion 13.

The legion 13 members may carry out some or all, but not limited to, the following operations:
each virtual vision 8 that is a member of legion 13 may propose to accept new members of the legion 13;
propose changing differentiating characteristics of the legions they are part of such as but not limited to “Name”, “Avatar”, “Presentation”, “Rules”, and others as the virtual visions 8 may consider necessary;
create content in a manner similar to that in the “Arena” 14 of the public section of the astral media 4;
enter into real-time communication with the other members of the respective legion 13;
share computer files and internet links setting up special legion 13 libraries;
create and indicate their willingness to take part or not in planned events posted in the special element 17 of the legion 13;
share with the other members of the legion 13 content posted by them or by other non-member virtual visions 8 in the “Arena” 14;
freely leave a given legion 13 and opt to send a message to that effect; and
propose the exclusion of members of the legions 13 they take part in.

The inclusion of new members in a legion 13 that has already been created in the “Legion Lemma” 11 is done after a prior decision of the legion 13 members is taken as to whether the approval requires full, qualified or simple majority of the vote of the member virtual visions.

The legion 13 is active as long as it has more than one virtual vision 8 as member of the Legion 13.

The termination of membership in a legion 13 that has already been created in the “Legion Lemma” 11 takes place after a prior decision of the legion 13 members is taken as to whether the approval requires full, qualified or simple majority of the vote of the member virtual visions.

The change of the characteristics of a legion 13 that has already been created in the “Legion Lemma” 11 shall be done after a prior decision of the legion 13 members is taken as to whether the approval requires full, qualified or simple majority of the vote of the member virtual visions.

Any other decision relating to major changes in the legion 13, i.e. everything excluding the posting of content by the legion 13 virtual visions, shall be approved by voting by the legion 13 members.

The astral media has an “urgent messaging” option by way of ensured and guaranteed access between the virtual visions 8. The astral media 4 allows each virtual vision 8 to indirectly communicate with the creator 1 regardless of where in the astral media 4 the creator 1 is and which other virtual vision 8 they navigate at this moment.

1. An astral media (4), positioned in a network (3), mostly online, whose users (1) access it via user devices (2) connected to the network (3) and upon registration in the astral media (4), the registered users (1) use this astral media (4) and communicate indirectly via at least one own virtual vision (8) by the creation of which each user becomes a creator and each virtual vision (8) ensures its creator (1) the absolute social and biological, regulated and mediated anonymity in a multilayered communicative fragmentation (9) comprised of at least a “Public Lemma” (10), “Legion Lemma” (11) and “MySelf Lemma” (12), with the communication between the virtual visions (8) of the creators being limited to the “Public Lemma” (10) and the “Legion Lemma” (11), whereas the “MySelf Lemma” (12) remains an individual virtual space of each creator (1) and the actions of all creators in the astral media (4) are mediated by their virtual visions (8) and take place in astronomical and/or specially measured astral media (4) time where the user interface of the first two lemmas is divided into right-hand and left-hand sections with the left-hand part information being visible only to its creator (1), and the right-hand part allowing for communication between different virtual visions (8), while the user interface of the “MySelf Lemma” (12) is not divided into right-hand and left-hand sections but is a single desktop unique for each creator (1) customized according to its creator's preferences.

2. The media according to claim 1, wherein the “Public Lemma” is universally accessible to all virtual visions of all creators registered in the media with every content posted by the creators at the public communication layer of the media and each created virtual vision being visible and accessible for interaction.

3. The media according to claim 2, wherein visually the “Public Lemma” is formed by two parts—a left-hand section called “Fountain” and a right-hand section called “Arena” which are divided by way of a frame forming a two-part door with the left-hand section “Fountain” that is visible only to the creator comprising elements assisting the creation of virtual visions and creator content, and the right-hand section “Arena” that is universally accessible to all virtual visions (8), visualizing all interactions between the virtual visions (8) at the public communication layer (10) of the astral media (4) and each content created by the virtual visions (8) in the “Public Lemma” being grouped based on fundamental type features called elements (16) which assist in the finding of appropriate content or other virtual visions (8).

4. The media according to claim 1, wherein the “Legion Lemma” (11) consists of a number of legions (13) each of which constitutes a closed communication community formed by at least two virtual visions (8) with the content posted in the respective legion (13) being visible only to its members and one virtual vision (8) being able to take part in an unlimited number of legions (13), which legions (13) possess their differentiating characteristics such as name, avatar, goals and rules accepted by all member by voting.

5. Media according to claim 4, wherein visually the “Legion Lemma” (11) is formed by two parts—a left-hand section called “Fountain” (18) and a right-hand section called “Arena” and visualizing only one “Legion” (19) with the left-hand section “Fountain” (18) being visible only to the creator (1) and consisting of elements assisting the creation of content for the legion selected in the right-hand section (19) which shows visualization of the interactions between the member virtual visions (8) in the selected legion (13) with each content created by the virtual visions (8) being grouped based on fundamental type features called elements (17), which assist in the finding of appropriate content or other virtual visions (8).

6. The media according to claim 1, wherein the “MySelf Lemma” (12) is directly connected to the creator (1) and constitutes his/her own protected and personalized space in the astral media (4), invisible to the other creators and providing an opportunity to install in the astral media (4) and use via any user device (2) connected to the network (3) of different software products such as file conversion software, text and graphic editors, readers for news content from external sites, systems for managing the creator's virtual visions in the astral media (4), as well as any other software allowing for one-way action initiated exclusively and only by the specific creator (1) within the media (4).

7. The media according to claim 1, wherein virtual vision (8) allows for full protection of the social and biological identity and anonymity of the creator (1) due to the option provided to set up specific characteristics of his/her specific virtual visions (8) such as name, description, avatar, and any other which the creator (1) may wish to share with the astral world, with each characteristic, name excluded, being subject to change in time by the creator (1) of the virtual vision (8).

8. The media according to claim 7, wherein the creator (1) of the virtual vision (8) is free to operate with it and change its differentiating characteristics (name excluding), delete it, revive it, leave it as memory for the other participants in the astral media (4) as well as bequeath it, transfer it and sell it to other creators (1) via their virtual visions (8).

9. The media according to claim 1, wherein the objectification of the virtual vision (8) in the astral media (4) by its creator (1) takes place at a present or future moment as selected by the creator.

10. The media according to claim 1, wherein the measuring of time intervals relating to actions in the media (4) is done in virtual terms different from astronomical times and 8.33 faster than astronomical time.

11. A method for the use of astral media according to claim 1, wherein the users perform the following sequence of operations:
(a) connect to the astral media via a computer network and user devices (2),
(b) register upon registration form in the astral media;
(c) create at least one active virtual vision (8) to be able to use the services of the astral media (4),
(i) wherein via the created virtual vision (8), the user (1), who is now a creator, is indirectly objectified and communicates freely and in a mediated manner on themes s/he prefers in the Public Lemma (10) and/or the Legion Lemma (11) of the multilayered communicative fragmentation (9) with other creators (1) via the virtual visions (8) they created and objectified, but not directly, and
(ii) wherein use of the “MySelf Lemma” (12) of the multilayered communicative fragmentation (9) is direct between the creator (1) and the astral media (4), but requires the existence of at least one virtual vision (8) of the creator (1).

12. The method according to claim 11, wherein in the “Public Lemma” (10) each creator (1) via at least one virtual vision (8) performs a choice of some or all of the following operations but not limited to them:
(a) post content in a specific element (16) of “Arena” (14);
(b) comment content in a specific element (16) of “Arena” (14);
(c) delete own content posted via his/her virtual visions (8) in a specific element (16) of “Arena” (14);
(d) classify based on certain features (themes) the information content posted by them and group in terms of meaning the general content posted by all creators (1) via their virtual visions (8) in different elements (16) of the “Public Lemma” (10) while at the same time being able to indirectly use the same criteria to classify all the virtual visions (8) interested in specific content relating to the theme;
(e) like, dislike or save content in their favorite content collection for a specific element (16) of the “Arena” (14);
(f) establish free public contacts with other virtual visions (8);
(g) share public audio, video, graphic, text and/or other files;
(h) create and vote for certain type of themes using his/her virtual visions (8);
(i) operate and manage their own virtual visions (8) by bequeathing, leaving as memory, deleting, transferring to other creators (l), etc.; and
(j) communicate via their virtual visions (8) with other virtual visions (8) of other creators (1) or with their own virtual visions in order to form legions (13) in the “Legion Lemma” (11).

13. The method according to claim 11, wherein creating a new legion (13) or issuing an invitation for an existing legion (13) in the “Legion Lemma” (11) is done based on prior communication between at least two virtual visions (8) at “Public Lemma” (10) level or “Legion Lemma” (11) level, wherein:
(a) the visualization of the contact between the two virtual visions (8) is positioned at a certain spot in the right-hand sections of the two lemmas;
(b) then an invitation is sent by one virtual vision (8) to the other to create a legion (13) whereupon:
(c) if the invitation is accepted the characteristics of the legion (13) are formed with those characteristics being unanimously approved by both virtual visions (8) and
(d) in case the invitation is not accepted by one of the virtual visions (8), no legion (13) is created;
(e) in which case the legion (13) is visible only to the virtual visions (8) which are members of the legion and the information posted by them is only accessible to them; and
(f) each legion (13) is active for as long as there is at least one virtual vision in it (8).

14. The method according to claim 1, wherein the participants in a legion (13) can perform but are not limited to the following operations:
(a) create content in a manner similar to that in the “Arena” (14);
(b) enter into real-time communication via text messaging;
(c) share files;
(d) post information about upcoming events;
(e) share content posted in the “Public Lemma” (10); and
(f) freely leave a given legion (13).

15. The method according to claim 11, wherein new member virtual visions (8) join a created legion (13) in the “Legion Lemma” (11) after a prior decision of the legion (13) members (8) is taken as to whether the approval requires full, qualified or simple majority of the vote of the member virtual visions (8).

16. The method according to claim 11, wherein the termination of membership in a legion (13) that has already been created in the “Legion Lemma” (11) takes place after a prior decision of the legion (13) members is taken as to whether the approval requires full, qualified or simple majority of the vote of the member virtual visions (8).

17. The method according to claim 11, wherein the change of the characteristics of a legion (13) that has already been created in the “Legion Lemma” (11) is done after a prior decision of the legion (13) members is taken as to whether the approval requires full, qualified or simple majority of the vote of the member virtual visions (8).

18. The method according to claim 11, wherein the system has an “urgent messaging” option by way of ensured and guaranteed access between the virtual visions (8) with the functionality of the astral media (4) allowing for indirect communication with the creator (1) of the virtual vision (8) regardless of where in the astral media (4) the creator is and which other virtual vision (8) they navigate at this moment.
